(19) United States
(12) Patent Application Publication
(10) Pub. No.: US 2024/0241529 A1
(43) Pub. Date: Jul. 18, 2024

(54) DUAL-CHAMBER PRESSURE CONTROL METHOD AND DUAL-CHAMBER PRESSURE CONTROL DEVICE

(71) Applicant: Naidun-tech Co., Ltd., Hsinchu City (TW)

(72) Inventors: Fu-Chieh Hsu, Kaohsiung (TW); Chun-Hung Hung, Kaohsiung (TW); Chun-Hung Hung, Kaohsiung (TW); Cheng-Hsiung Lee, Kaohsiung (TW)

(21) Appl. No.: 18/415,611

(22) Filed: Jan. 17, 2024

(30) Foreign Application Priority Data
Jan. 18, 2023 (TW) 112102352

(51) Int. Cl. G05D 16/20

(52) U.S. Cl. CPC G05D 16/204

(57) ABSTRACT

A dual-chamber pressure control method and a dual-chamber pressure control device are described. The dual-chamber pressure control method uses a stepped pressure adjustment to ensure that the pressure adjustment at each stage will not exceed a safe value of an internal chamber body. The dual-chamber pressure control device includes a dual-chamber member, an external chamber pressure control module, and an internal chamber pressure control module. The external chamber pressure control module is used to adjust an external chamber pressure of the dual-chamber member, such that an external chamber pressure value changes with time to show a stepped external chamber pressure adjustment line. The internal chamber pressure control module is used to adjust an internal chamber pressure of the dual-chamber member, such that an internal chamber pressure value changes with time to show a stepped internal chamber pressure adjustment line.

### RELATED APPLICATIONS

This application claims priority to Taiwan Application Serial No. 112102352, filed Jan. 18, 2023, which is herein incorporated by reference.

### BACKGROUND

### Field of Invention

The present disclosure relates to a pressure control method and a pressure control device, and more particularly, to a dual-chamber pressure control method and a dual-chamber pressure control device.

### Description of Related Art

In a semiconductor process, semiconductor materials can be thermally treated in a reactive gas environment to reduce the number of dangling bonds in the semiconductor device and enhance the performance of the semiconductor device. In the thermal treatment process, temperature or time of the thermal treatment can be reduced by increasing the pressure, so as to enhance the efficiency.

A dual-chamber reaction apparatus of an existing high-pressure annealing member includes an external chamber body, an internal chamber body, and a differential pressure transmitter. The internal chamber body is located within the external chamber body. The differential pressure transmitter is fixed on a top of the external chamber body and communicates with an external chamber of the external chamber body and an internal chamber of the internal chamber body. The internal chamber is filled with a reactive gas. The external chamber is filled with an inert gas. A pressure difference method is used to control a pressure in the internal chamber body and a pressure in the external chamber body to form a pressure difference between the internal chamber body and the external chamber body. However, the pressure difference method has a problem that the pressurization speed is too fast, such that the pressure difference between the internal chamber and the external chamber is difficult to control, and the internal chamber body may even be damaged due to excessive pressure.

In addition, after the annealing process of the semiconductor material in the high-pressure annealing member is completed, the reactive gas and the inert gas are mixed in the pressure control valve and then discharged, such that it is difficult to recover and reuse the reactive gas.

### SUMMARY

Therefore, one objective of the present disclosure is to provide a dual-chamber pressure control method and a dual-chamber pressure control device, which solves the problem that an internal chamber body is easy damaged due to excessive pressure increase, and reduces the difficulty of recovering and reusing reactive gas.

According to the aforementioned objectives, the present disclosure provides a dual-chamber pressure control method. The dual-chamber pressure control method first uses an external chamber pressure control module and an internal chamber pressure control module to respectively obtain an external chamber pressure value and an internal chamber pressure value of a double-chamber member before pressure adjusting. A stepped pressure adjustment is performed to use the external chamber pressure control module to adjust an external chamber pressure adjustment value of an inert gas in an external chamber, and to use the internal chamber pressure control module to adjust an internal chamber pressure adjustment value of a reactive gas in an internal chamber. The stepped pressure adjustment are repeated plural times until the external chamber pressure value is adjusted to a final external chamber pressure value, and the internal chamber pressure value is adjusted to a final internal chamber pressure value.

According to one embodiment of the present disclosure, in the stepped pressure adjustment, the external chamber pressure adjustment value is increased first, and then the internal chamber pressure adjustment value is increased.

According to one embodiment of the present disclosure, in the stepped pressure adjustment, the internal chamber pressure adjustment value is decreased first, and then the external chamber pressure adjustment value is decreased.

According to one embodiment of the present disclosure, in the stepped pressure adjustment, the internal chamber pressure adjustment value and the external chamber pressure adjustment value are adjusted simultaneously.

According to one embodiment of the present disclosure, in the stepped pressure adjustment, the internal chamber pressure adjustment value and the external chamber pressure adjustment value are adjusted simultaneously, and an external chamber pressure protection component and an internal chamber pressure protection component are used to ensure that the external chamber and the internal chamber are at equal pressure.

According to one embodiment of the present disclosure, the external chamber pressure adjustment value is ranging from 0.01 bar to 20 bar, and the internal chamber pressure adjustment value is ranging from 0.01 bar to 20 bar.

According to the aforementioned objectives, the present disclosure provides a dual-chamber pressure control device. The dual-chamber pressure control device includes a dual-chamber member, an external chamber pressure control module, and an internal chamber pressure control module. The dual-chamber member includes an external chamber and an internal chamber. The external chamber is configured to accommodate an inert gas. The internal chamber is adjacent to the external chamber and is not communicating with the external chamber, and is configured to accommodate a reactive gas. The external chamber pressure control module is connected to the external chamber and is configured to adjust an external chamber pressure of the inert gas in the external chamber, such that an external chamber pressure value of the external chamber changes with time to show a stepped external chamber pressure adjustment line. The internal chamber pressure control module is connected to the internal chamber and is configured to adjust an internal chamber pressure of the reactive gas in the internal chamber, such that an internal chamber pressure value of the internal chamber changes with time to show a stepped internal chamber pressure adjustment line.

According to one embodiment of the present disclosure, the external chamber pressure control module includes an external pressurizing component, an external chamber pressure transmission component, and an external chamber pressure control component. The external pressurizing component is connected to the external chamber and is configured to increase the external chamber pressure value. The external chamber pressure transmission component is connected to the external chamber and is configured to measure the external chamber pressure value. The external chamber pressure control component is connected to the external chamber and is configured to control the external chamber pressure value. The internal chamber pressure control module includes an internal pressurizing component, an internal chamber pressure transmission component, and an internal chamber pressure control component. The internal pressurizing component is connected to the internal chamber and is configured to increase the internal chamber pressure value. The internal chamber pressure transmission component is connected to the internal chamber and is configured to measure the internal chamber pressure value. The internal chamber pressure control component is connected to the internal chamber and is configured to control the internal chamber pressure value.

According to one embodiment of the present disclosure, each of the external pressurizing component and the internal pressurizing component is a boosting pump, a combination of the boosting pump and a mass flow meter, or a combination of the boosting pump and a mass flow controller.

According to one embodiment of the present disclosure, each of the external chamber pressure transmission component and the internal chamber pressure transmission component is a pressure transmitter, or a combination of the pressure transmitter and a differential pressure transmitter.

According to one embodiment of the present disclosure, each of the external chamber pressure control component and the internal chamber pressure control component is a pressure regulator, an electronic pressure control valve, or a combination of the pressure regulator and the electronic pressure control valve.

According to one embodiment of the present disclosure, the external chamber pressure control module includes an external chamber pressure protection component. The external chamber pressure protection component is connected to the external chamber. A set pressure value of the external chamber pressure protection component is greater than a set pressure value of the external chamber pressure control component by 0.3 bar to 3 bar. The internal chamber pressure control module includes an internal chamber pressure protection component. The internal chamber pressure protection component is connected to the internal chamber. A set pressure value of the internal chamber pressure protection component is greater than a set pressure value of the internal chamber pressure control component by 0.3 bar to 3 bar.

According to one embodiment of the present disclosure, the dual-chamber member includes an external chamber body, an internal chamber body, and a sealing ring. The internal chamber body is disposed in the external chamber body. The sealing ring is disposed between the external chamber body and the internal chamber body, and is configured to isolate the inert gas in the external chamber and the reactive gas in the internal chamber.

According to one embodiment of the present disclosure, the internal chamber body is a component made of a non-metallic material or an anti-pollution metal material.

According to one embodiment of the present disclosure, a material of the internal chamber body comprises quartz, ceramics, glass, silicon carbide, or nickel alloy.

According to the aforementioned description, it is known that the dual-chamber pressure control method uses the external chamber pressure control module and the internal chamber pressure control module of the dual-chamber pressure control device to perform stepped pressure adjustments on the external chamber pressure and the internal chamber pressure respectively, such that it can ensure that the pressure adjustment at each stage will not exceed the safe value that the internal chamber body can withstand, thereby preventing the internal chamber body from being damaged and the inert gas and the reactive gas from mixing, which facilitates the recovery of the reactive gas. The internal chamber of the double-chamber member is not communicating with the external chamber, such that it can prevent the inert gas and the reactive gas from mixing.

### BRIEF DESCRIPTION OF THE DRAWINGS

In order to make the above and other objectives, features, advantages, and embodiments of the present disclosure more obvious and understandable, the accompanying drawings are described as follows:

FIG. 1 is a schematic cross-sectional view of a dual-chamber pressure control device in accordance with one embodiment of the present disclosure;

FIG. 2A is a schematic diagram of a stepped external chamber pressure adjustment line showing how an external chamber pressure value changes with time when the dual-chamber pressure control device performs pressurization;

FIG. 2B is a schematic diagram of a stepped external chamber pressure adjustment line showing how the external chamber pressure value changes with time when the dual-chamber pressure control device performs pressure decompression;

FIG. 3A is a schematic diagram of a stepped internal chamber pressure adjustment line showing how an internal chamber pressure value changes with time when the dual-chamber pressure control device performs pressurization;

FIG. 3B is a schematic diagram of a stepped internal chamber pressure adjustment line showing how the internal chamber pressure value changes with time when the dual-chamber pressure control device performs pressure decompression;

FIG. 4 is a schematic flow chart of a dual-chamber pressure control method in accordance with one embodiment of the present disclosure;

FIG. 5A and FIG. 5B are respectively schematic device diagrams when a dual-chamber pressure control method sequentially increases the external chamber pressure and the internal chamber pressure;

FIG. 5C and FIG. 5D are respectively schematic device diagrams when the dual-chamber pressure control method sequentially reduces the internal chamber pressure and the external chamber pressure;

FIG. 6A is a schematic device diagram when the dual-chamber pressure control method simultaneously increases the external chamber pressure and the internal chamber pressure;

FIG. 6B is a schematic device diagram when the dual-chamber pressure control method simultaneously reduces the external chamber pressure and the internal chamber pressure; and

FIG. 7 is a schematic device diagram when the dual chamber pressure control method uses an external chamber pressure protection component and an internal chamber pressure protection component to assist the adjustment of the external chamber pressure and the internal chamber pressure.

### DETAILED DESCRIPTION

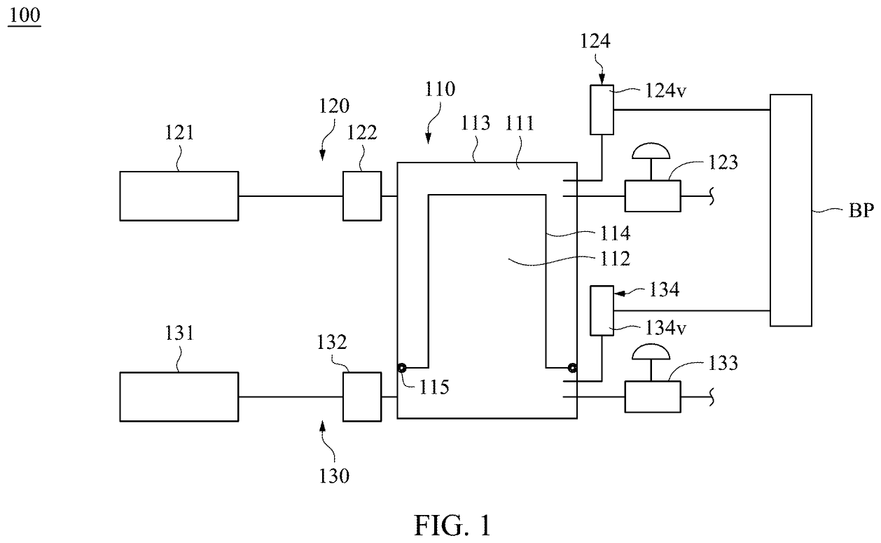

Referring to FIG. 1, FIG. 1 is a schematic cross-sectional view of a dual-chamber pressure control device 100 in accordance with one embodiment of the present disclosure. The dual-chamber pressure control device 100 includes a dual-chamber member 110, an external chamber pressure control module 120, and an internal chamber pressure control module 130.

Continuing to refer to FIG. 1, the dual-chamber member 110 includes an external chamber 111 and an internal chamber 112. The external chamber 111 is configured to accommodate an inert gas. The internal chamber 112 is adjacent to the external chamber 111 and not connected to the external chamber 111, and is configured to accommodate a reactive gas. In one example, the dual-chamber member 110 includes an external chamber body 113, an internal chamber body 114, and a sealing ring 115. The internal chamber body 114 is disposed in the external chamber body 113. The internal chamber 112 is located within the internal chamber body 114. The external chamber 111 is located between the external chamber body 113 and the internal chamber body 114. The sealing ring 115 is disposed between the external chamber body 113 and the internal chamber body 114, and is configured to isolate the inert gas in the external chamber 111 and the reactive gas in the internal chamber 112. That is, the sealing ring 115 is against the internal chamber body 114 and the external chamber body 113, such that inert gas and reactive gas will not flow through the gap between the internal chamber body 114 and the external chamber body 113. In one example, the external chamber body 113 may be made of metal. In one example, the internal chamber body 114 may be a component that is made of a non-metallic material or an anti-pollution metal material. A material of the internal chamber body 114 may include quartz, ceramics, glass, silicon carbide, or nickel alloy. The anti-pollution metal material may be selected from Inconel, Monel, or Hastelloy.

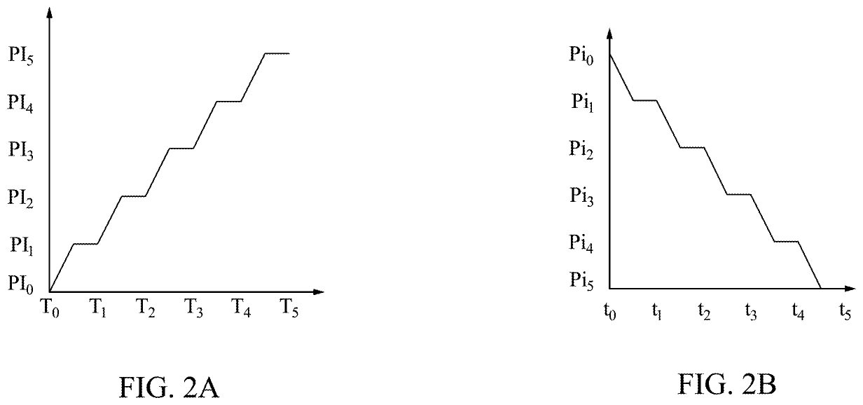

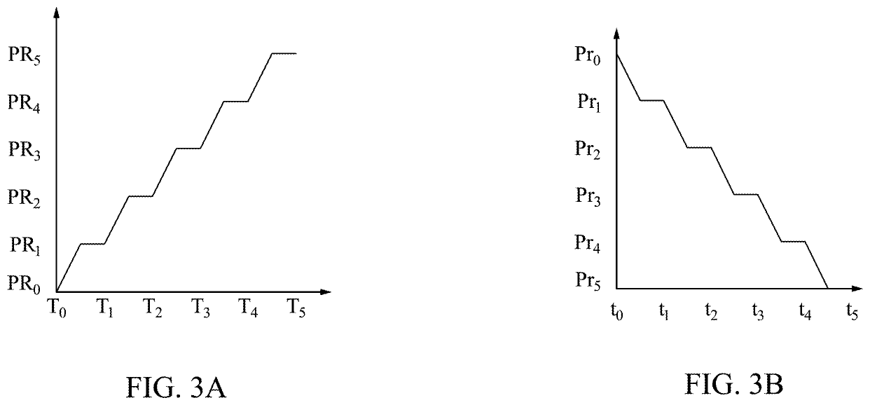

Continue to refer to FIG. 1, and refer to FIG. 2A and FIG. 2B together. FIG. 2A is a schematic diagram of a stepped external chamber pressure adjustment line showing how an external chamber pressure value changes with time when the dual-chamber pressure control device 100 performs pressurization. FIG. 2B is a schematic diagram of a stepped external chamber pressure adjustment line showing how the external chamber pressure value changes with time when the dual-chamber pressure control device 100 performs pressure decompression. The external chamber pressure control module 120 is connected to the external chamber 111 of the dual-chamber member 110 and is configured to adjust an external chamber pressure of the inert gas in the external chamber 111, such that an external chamber pressure value of the external chamber 111 changes with time to show a stepped external chamber pressure adjustment line. When pressurizing, the stepped external chamber pressure adjustment line is upward, that is, the external chamber pressure value increases stepwise as time increases. When decompressing, the stepped external chamber pressure adjustment line is downward, that is, the external chamber pressure value decreases stepwise as time increases.

Specifically, continuing to refer to FIG. 2A, take five pressurizing stages as an example. A first pressurizing stage is from an initial pressurizing time T₀ to a first stage pressurizing time T₁. The external chamber pressure of the inert gas in the external chamber 111 is increased from an initial pressurized external chamber pressure value PI₀ to a first stage pressurized external chamber pressure value PI₁, and the first stage pressurized external chamber pressure value PI₁ is maintained for a period of time to form a first pressurized step section of the stepped external chamber pressure adjustment line. The initial pressurized external chamber pressure value PI₀ may be ranging from normal pressure to 20 bar. Further, the initial pressurized external chamber pressure value PI₀ may be ranging from normal pressure to 5 bar.

Then, a second pressurizing stage that is the pressurizing between the first stage pressurizing time T₁ and a second stage pressurizing time T₂ is performed. The external chamber pressure of the inert gas in the external chamber 111 is increased from the first stage pressurized external chamber pressure value PI₁ to a second stage pressurized external chamber pressure value PI₂, and the second stage pressurized external chamber pressure value PI₂ is maintained for a period of time to form a second pressurized step section of the stepped external chamber pressure adjustment line. The second stage pressurized external chamber pressure value PI₂ is 0.01 bar to 20 bar greater than the first stage pressurized external chamber pressure value PI₁. Further, the second stage pressurized external chamber pressure value PI₂ is 0.1 bar to 5 bar greater than the first stage pressurized external chamber pressure value PI₁. By analogy, the third stage, the fourth stage, and the fifth stage of pressurizing can be performed in sequence. The number of stages of pressurizing can be adjusted according to requirements. In the third pressurizing stage, which is between the second pressurizing stage time T₂ and a third pressurizing stage time T₃, the external chamber pressure is increased from the second stage pressurized external chamber pressure value PI₂ to a third stage pressurized external chamber pressure value PI₃. In the fourth pressurizing stage, which is between the third pressurizing stage time T₃ and a fourth pressurizing stage time T₄, the external chamber pressure is increased from the third stage pressurized external chamber pressure value PI₃ to a fourth stage pressurized external chamber pressure value PI₄. In the fifth pressurizing stage, which is between the fourth pressurizing stage time T₄ and a fifth pressurizing stage time T₅, the external chamber pressure is increased from the fourth stage pressurized external chamber pressure value PI₄ to a fifth stage pressurized external chamber pressure value PI₅.

Then, referring to FIG. 2B, take five decompressing stages as an example. A first decompressing stage is from an initial decompressing time t₀ to a first stage decompressing time t₁. The external chamber pressure of the inert gas in the external chamber 111 is decreased from an initial decompressed external chamber pressure value Pi₀ to a first stage decompressed external chamber pressure value Pi₁, and the first stage decompressed external chamber pressure value Pi₁ is maintained for a period of time to form a first decompressed step section of the stepped external chamber pressure adjustment line.

Then, a second decompressing stage that is the decompressing between the first stage decompressing time t₁ and a second stage decompressing time t₂ is performed. The external chamber pressure of the inert gas in the external chamber 111 is decreased from the first stage decompressed external chamber pressure value Pi₁ to a second stage decompressed external chamber pressure value Pi₂, and the second stage decompressed external chamber pressure value Pi₂ is maintained for a period of time to form a second decompressed step section of the stepped external chamber pressure adjustment line. The second stage decompressed external chamber pressure value Pi₂ is 0.01 bar to 20 bar smaller than the first stage decompressed external chamber pressure value Pi₁. Further, the second stage decompressed external chamber pressure value Pi₂ is 0.1 bar to 5 bar smaller than the first stage decompressed external chamber pressure value Pi₁. By analogy, the third stage, the fourth stage, and the fifth stage of decompressing can be performed in sequence. The number of stages of decompressing can be adjusted according to requirements. In the third decompressing stage, which is between the second decompressing stage time t₂ and a third decompressing stage time t₃, the external chamber pressure is decreased from the second stage decompressed external chamber pressure value Pi₂ to a third stage decompressed external chamber pressure value Pi₃. In the fourth decompressing stage, which is between the third decompressing stage time t₃ and a fourth decompressing stage time t₄, the external chamber pressure is decreased from the third stage decompressed external chamber pressure value Pi₃ to a fourth stage decompressed external chamber pressure value Pi₄. In the fifth decompressing stage, which is between the fourth decompressing stage time t₄ and a fifth decompressing stage time t₅, the external chamber pressure is decreased from the fourth stage decompressed external chamber pressure value Pi₄ to a fifth stage decompressed external chamber pressure value Pi₅. The final decompressed external chamber pressure value Pi₅ may be ranging from normal pressure to 20 bar. Further, the final decompressed external chamber pressure value Pi₅ may be ranging from normal pressure to 5 bar.

Continuing to refer to FIG. 1, the external chamber pressure control module 120 includes an external pressurizing component 121, an external chamber pressure transmission component 122, and an external chamber pressure control component 123. The external pressurizing component 121 is connected to the external chamber 111, and is configured to increase the external chamber pressure value. In one example, the external pressurizing component 121 may be a boosting pump. In one example, the external pressurizing component 121 may be a combination of the boosting pump and a mass flow meter. In one example, the external pressurizing component 121 may be a combination of the boosting pump and a mass flow controller.

Continuing to refer to FIG. 1, the external chamber pressure transmission component 122 is connected to the external chamber 111, and is configured to measure the external chamber pressure value. In one example, the external chamber pressure transmission component 122 may be a pressure transmitter. In one example, the external chamber pressure transmission component 122 may be a combination of the pressure transmitter and a differential pressure transmitter.

Continuing to refer to FIG. 1, the external chamber pressure control component 123 is connected to the external chamber 111, and is configured to control the external chamber pressure value. In one example, the external chamber pressure control component 123 may be a pressure regulator. In one example, the external chamber pressure control component 123 may be an electronic pressure control valve. In one example, the external chamber pressure control component 123 may be a combination of the pressure regulator and the electronic pressure control valve.

In one example, the external chamber pressure control module 120 further includes an external chamber pressure protection component 124. The external chamber pressure protection component 124 is connected to the external chamber 111. In one example, the external chamber pressure protection component 124 may be located between the external chamber 111 and the external chamber pressure control component 123. In another example, the external chamber pressure protection component 124 and the external chamber pressure control component 123 are respectively connected to the external chamber 111. A set pressure value of the external chamber pressure protection component 124 is greater than a set pressure value of the external chamber pressure control component 123 by 0.3 bar to 3 bar. In one example, the set pressure value of the external chamber pressure protection component 124 is 1 bar greater than the set pressure value of the external chamber pressure control component 123, i.e., when the set pressure value of the external chamber pressure control component 123 is 10 bar, the set pressure value of the external chamber pressure protection component 124 is 11 bar. When the external chamber pressure is greater than 12 bar, the external chamber pressure protection component 124 can discharge a portion of the inert gas in the external chamber 111 to adjust the external chamber pressure to 11 bar, so as to prevent the external chamber pressure from being too high and damaging the internal chamber body 114. In one example, the external chamber pressure protection component 124 may be a combination of a one-way valve 124v and a back pressure unit BP. A set pressure value of the back pressure unit BP is greater than the set pressure value of the external chamber pressure control component 123 by 0.3 bar to 3 bar, preferably by 1 bar.

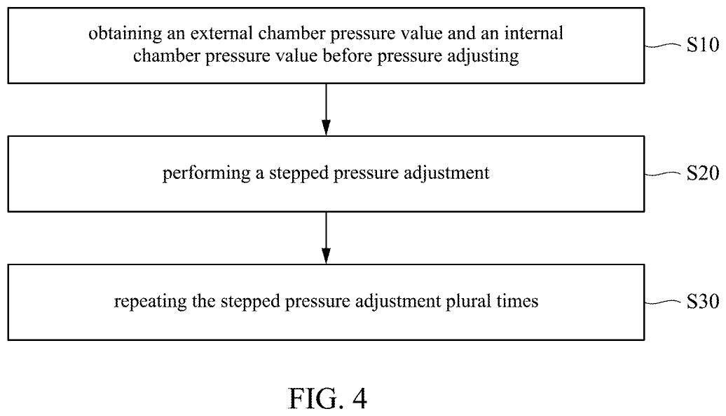

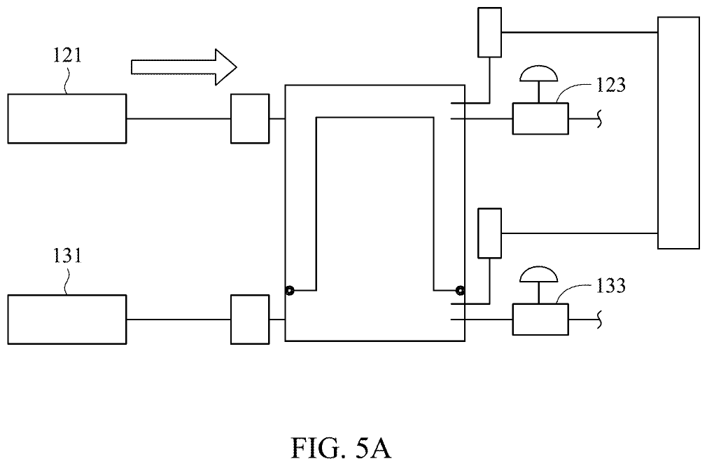

Continue to refer to FIG. 1, and refer to FIG. 3A and FIG. 3B together. FIG. 3A is a schematic diagram of a stepped internal chamber pressure adjustment line showing how an internal chamber pressure value changes with time when the dual-chamber pressure control device 100 performs pressurization. FIG. 3B is a schematic diagram of a stepped internal chamber pressure adjustment line showing how the internal chamber pressure value changes with time when the dual-chamber pressure control device 100 performs decompression. The internal chamber pressure control module 130 is connected to the internal chamber 112 of the dual-chamber member 110 and is configured to adjust an internal chamber pressure of the reactive gas in the internal chamber 112, such that an internal chamber pressure value of the internal chamber 112 changes with time to show a stepped internal chamber pressure adjustment line. When pressurizing, the stepped internal chamber pressure adjustment line is upward, that is, the internal chamber pressure value increases stepwise as time increases. When decompressing, the stepped internal chamber pressure adjustment line is downward, that is, the internal chamber pressure value decreases stepwise as time increases.

Specifically, continuing to refer to FIG. 3A, take five pressurizing stages as an example. A first pressurizing stage is from an initial pressurizing time T₀ to a first stage pressurizing time T₁. The internal chamber pressure of the reactive gas in the internal chamber 112 is increased from an initial pressurized internal chamber pressure value PR₀ to a first stage pressurized internal chamber pressure value PR₁, and the first stage pressurized internal chamber pressure value PR₁ is maintained for a period of time to form a first pressurized step section of the stepped internal chamber pressure adjustment line. The initial pressurized internal chamber pressure value PR₀ may be normal pressure.

Then, a second pressurizing stage that is the pressurizing between the first stage pressurizing time T₁ and a second stage pressurizing time T₂ is performed. The internal chamber pressure of the reactive gas in the internal chamber 112 is increased from the first stage pressurized internal chamber pressure value PR₁ to a second stage pressurized internal chamber pressure value PR₂, and the second stage pressurized external chamber pressure value PR₂ is maintained for a period of time to form a second pressurized step section of the stepped internal chamber pressure adjustment line. The second stage pressurized internal chamber pressure value PR₂ is 0.01 bar to 20 bar greater than the first stage pressurized internal chamber pressure value PR₁. Further, the second stage pressurized internal chamber pressure value PR₂ is 0.1 bar to 5 bar greater than the first stage pressurized internal chamber pressure value PR₁. By analogy, the third stage, the fourth stage, and the fifth stage of pressurizing can be performed in sequence. The number of stages of pressurizing can be adjusted according to requirements. In the third pressurizing stage, which is between the second pressurizing stage time T₂ and a third pressurizing stage time T₃, the internal chamber pressure is increased from the second stage pressurized internal chamber pressure value PR₂ to a third stage pressurized internal chamber pressure value PR₃. In the fourth pressurizing stage, which is between the third pressurizing stage time T₃ and a fourth pressurizing stage time T₄, the internal chamber pressure is increased from the third stage pressurized internal chamber pressure value PR₃ to a fourth stage pressurized internal chamber pressure value PR₄. In the fifth pressurizing stage, which is between the fourth pressurizing stage time T₄ and a fifth pressurizing stage time T₅, the internal chamber pressure is increased from the fourth stage pressurized internal chamber pressure value PR₄ to a fifth stage pressurized internal chamber pressure value PR₅.

Then, referring to FIG. 3B, take five decompressing stages as an example. A first decompressing stage is from an initial decompressing time t₀ to a first stage decompressing time t₁. The internal chamber pressure of the reactive gas in the internal chamber 112 is decreased from an initial decompressed internal chamber pressure value Pr₀ to a first stage decompressed internal chamber pressure value Pr₁, and the first stage decompressed internal chamber pressure value Pr₁ is maintained for a period of time to form a first decompressed step section of the stepped internal chamber pressure adjustment line.

Then, a second decompressing stage that is the decompressing between the first stage decompressing time t₁ and a second stage decompressing time t₂ is performed. The internal chamber pressure of the reactive gas in the internal chamber 112 is decreased from the first stage decompressed internal chamber pressure value Pr₁ to a second stage decompressed internal chamber pressure value Pr₂, and the second stage decompressed internal chamber pressure value Pr₂ is maintained for a period of time to form a second decompressed step section of the stepped internal chamber pressure adjustment line. The second stage decompressed internal chamber pressure value Pr₂ is 0.01 bar to 20 bar smaller than the first stage decompressed internal chamber pressure value Pr₁. Further, the second stage decompressed internal chamber pressure value Pr₂ is 0.1 bar to 5 bar smaller than the first stage decompressed internal chamber pressure value Pr₁. By analogy, the third stage, the fourth stage, and the fifth stage of decompressing can be performed in sequence. The number of stages of decompressing can be adjusted according to requirements. In the third decompressing stage, which is between the second decompressing stage time t₂ and a third decompressing stage time t₃, the internal chamber pressure is decreased from the second stage decompressed internal chamber pressure value Pr₂ to a third stage decompressed external chamber pressure value Pr₃. In the fourth decompressing stage, which is between the third decompressing stage time t₃ and a fourth decompressing stage time t₄, the internal chamber pressure is decreased from the third stage decompressed internal chamber pressure value Pr₃ to a fourth stage decompressed internal chamber pressure value Pr₄. In the fifth decompressing stage, which is between the fourth decompressing stage time t₄ and a fifth decompressing stage time t₅, the internal chamber pressure is decreased from the fourth stage decompressed internal chamber pressure value Pr₄ to a fifth stage decompressed internal chamber pressure value Pr₅. The final decompressed internal chamber pressure value Pr₅ may be normal pressure.

Continuing to refer to FIG. 1, the internal chamber pressure control module 130 includes an internal pressurizing component 131, an internal chamber pressure transmission component 132, and an internal chamber pressure control component 133. The internal pressurizing component 131 is connected to the internal chamber 112, and is configured to increase the internal chamber pressure value. In one example, the internal pressurizing component 131 may be a boosting pump. In one example, the internal pressurizing component 131 may be a combination of the boosting pump and a mass flow meter. In one example, the internal pressurizing component 131 may be a combination of the boosting pump and a mass flow controller.

Continuing to refer to FIG. 1, the internal chamber pressure transmission component 132 is connected to the internal chamber 112, and is configured to measure the internal chamber pressure value. In one example, the internal chamber pressure transmission component 132 may be a pressure transmitter. In one example, the internal chamber pressure transmission component 132 may be a combination of the pressure transmitter and a differential pressure transmitter. The external chamber pressure transmission component 122 and the internal chamber pressure transmission component 132 share the same differential pressure transmitter. When the external chamber pressure transmission component 122 and the internal chamber pressure transmission component 132 are the same differential pressure transmitter, the differential pressure transmitter is connected to the external chamber 111 and internal chamber 112. When the external chamber pressure transmission component 122 and the internal chamber pressure transmission component 132 are the pressure transmitters, it is unnecessary to connect the external chamber pressure transmission component 122 and the internal chamber pressure transmission component 132 by using a pipe.

Continuing to refer to FIG. 1, the internal chamber pressure control component 133 is connected to the internal chamber 112, and is configured to control the internal chamber pressure value. In one example, the internal chamber pressure control component 133 may be a pressure regulator. In one example, the internal chamber pressure control component 133 may be an electronic pressure control valve. In one example, the internal chamber pressure control component 133 may be a combination of the pressure regulator and the electronic pressure control valve.

In one example, the internal chamber pressure control module 130 further includes an internal chamber pressure protection component 134. The internal chamber pressure protection component 134 is connected to the internal chamber 112. In one example, the internal chamber pressure protection component 134 is located between the internal chamber 112 and the internal chamber pressure control component 133. In another example, the internal chamber pressure protection component 134 and the internal chamber pressure control component 133 are respectively connected to the internal chamber 112. A set pressure value of the internal chamber pressure protection component 134 is greater than a set pressure value of the internal chamber pressure control component 133 by 0.3 bar to 3 bar. Taking the set pressure value of the internal chamber pressure protection component 134 is 1 bar greater than the set pressure value of the internal chamber pressure control component 133 as an example, when the set pressure value of the internal chamber pressure control component 133 is 10 bar, the set pressure value of the internal chamber pressure protection component 134 is 11 bar. When the internal chamber pressure is greater than 12 bar, the internal chamber pressure protection component 134 can discharge a portion of the reactive gas in the internal chamber 112 to adjust the internal chamber pressure to 11 bar, so as to prevent the internal chamber pressure from being too high and damaging the internal chamber body 114. In one example, the internal chamber pressure protection component 134 may be a combination of a one-way valve 134v and the back pressure unit BP. A set pressure value of the back pressure unit BP is greater than the set pressure value of the internal chamber pressure control component 133 by 0.3 bar to 3 bar, and preferably by 1 bar.

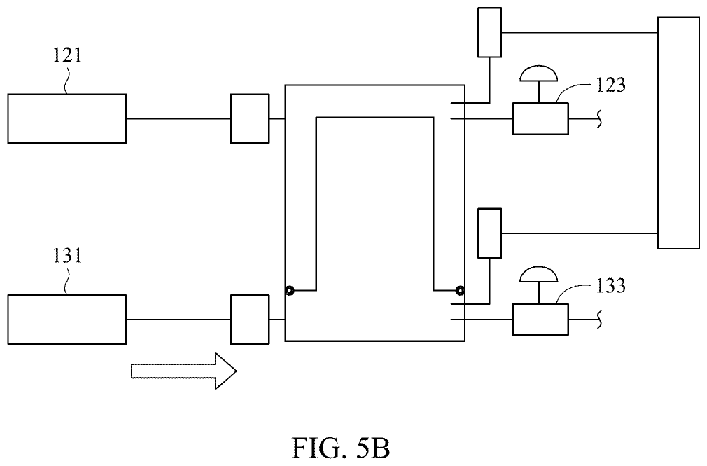

Refer to FIG. 4 and FIG. 1 simultaneously. FIG. 4 is a schematic flow chart of a dual-chamber pressure control method in accordance with one embodiment of the present disclosure. The dual-chamber pressure control device 100 is used to control the internal chamber pressure and the external chamber pressure of the dual-chamber member 110, that is, to increase pressure or decrease pressure. That is, the internal chamber pressure and the external chamber pressure are increased, or the internal chamber pressure and the external chamber pressure are decreased. In the control method performed by using the dual-chamber pressure control device 100, a step S10 is first performed. The external chamber pressure control module 120 and the internal chamber pressure control module 130 are used to respectively obtain an external chamber pressure value and an internal chamber pressure value of the dual-chamber member 110 before pressure adjusting. That is, the external chamber pressure control module 120 is used to obtain an initial external chamber pressure value, and the internal chamber pressure control module 130 is used to obtain an initial internal chamber pressure value.

In the pressurization process, the initial external chamber pressure value obtained by the external chamber pressure control module 120 may be the minimum external chamber pressure value, and the initial internal chamber pressure value obtained by the internal chamber pressure control module 130 may be the minimum internal chamber pressure value. In one example, in the pressurization process, the initial external chamber pressure value may be normal pressure, and the initial internal chamber pressure value may be normal pressure. In the decompression process, the initial external chamber pressure value obtained by the external chamber pressure control module 120 may be the maximum external chamber pressure value, and the initial internal chamber pressure value obtained by the internal chamber pressure control module 130 may be the maximum internal chamber pressure value. In one example, in the decompression process, the initial external chamber pressure value may be 10 bar to 300 bar, and the initial internal chamber pressure value may be 10 bar to 300 bar.

Continuing to refer to FIG. 4, after the external chamber pressure value and the internal chamber pressure value before pressure adjusting are obtained, a step S20 is performed, i.e. a stepped pressure adjustment is performed. An external chamber pressure adjustment value for an inert gas in the external chamber 111 is adjusted by using the external chamber pressure control module 120, and an internal chamber pressure adjustment value for the reactive gas in the internal chamber 112 is adjusted by using the internal chamber pressure control module 130. The external chamber pressure adjustment value is ranging from 0.01 bar to 20 bar, and the internal chamber pressure adjustment value is ranging from 0.01 bar to 20 bar.

Then, a step S30 is performed. The stepped pressure adjustment is repeated several times until the external chamber pressure value is adjusted to a final external chamber pressure value, and the internal chamber pressure value is adjusted to a final internal chamber pressure value. In the repeating of the stepped pressure adjustment, the external chamber pressure adjustment value is ranging from 0.01 bar to 20 bar, and the internal chamber pressure adjustment value is ranging from 0.01 bar to 20 bar. It is not necessary to use the same external chamber pressure adjustment value and the same internal chamber pressure adjustment value for all stages of the stepped pressure adjustment. For example, in the first stage of the stepped pressure adjustment, the external chamber pressure adjustment value and the internal chamber pressure adjustment value are set at 2 bar. In other stages of the stepped pressure adjustment, the external chamber pressure adjustment value and the internal chamber pressure adjustment value may be set from 1 bar to 5 bar, and preferably 2 bar.

In the pressurization process, the final external chamber pressure value may be the maximum external chamber pressure value, and the final internal chamber pressure value may be the maximum internal chamber pressure value. In one example, in the pressurization process, the final external chamber pressure value may be ranging from 10 bar to 300 bar, and the final internal chamber pressure value may be ranging from 10 bar to 300 bar. In the decompression process, the final external chamber pressure value may be the minimum external chamber pressure value, and the final internal chamber pressure value may be the minimum internal chamber pressure value. In one example, in the decompression process, the final external chamber pressure value may be normal pressure, and the final internal chamber pressure value may be normal pressure.

In each of the stages of the stepped pressure adjustment, the external chamber pressure value may be greater than, smaller than, or equal to the internal chamber pressure value. Specifically, the external chamber pressure value minus the internal chamber pressure value is equal to a value ranging from 0 bar to 20 bar, or may be equal to a value ranging from 0 bar to −20 bar. When the external chamber pressure value minus the internal chamber pressure value is equal to 0 bar, it means that the external chamber pressure value is equal to the internal chamber pressure value. When the external chamber pressure value minus the internal chamber pressure value is greater than 0 bar, it means that the external chamber pressure value is greater than the internal chamber pressure value. When the external chamber pressure value minus the internal chamber pressure value is smaller than 0 bar, it means that the external chamber pressure value is smaller than the internal chamber pressure value. In one example, the external chamber pressure value minus the internal chamber pressure value is equal to a value ranging from 0 bar to 5 bar, or may be equal to value ranging from 0 bar to −5 bar. The relative pressure difference is controlled at a safe value that the structure of the internal chamber body 114 can withstand by the external chamber pressure control module 120 and the internal chamber pressure control module 130, such that the internal chamber body 114 is prevented from being damaged, thereby preventing the inert gas and the reactive gas from mixing through the damaged internal chamber body 114.

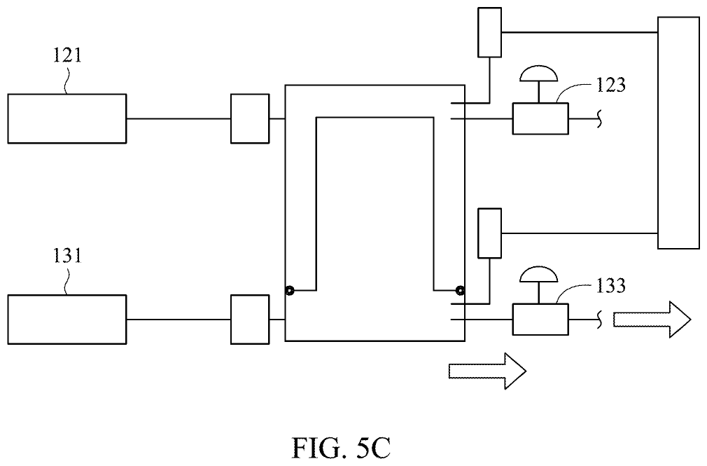

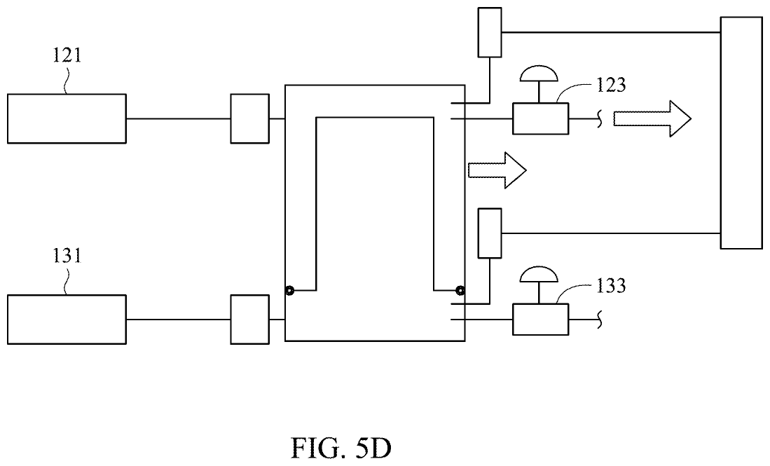

Referring to FIG. 5A and FIG. 5B, FIG. 5A and FIG. 5B are respectively schematic device diagrams when a dual-chamber pressure control method sequentially increases the external chamber pressure and the internal chamber pressure. In each stage of the stepped pressure adjustment step in the pressurization process, the external chamber pressure adjustment value and the internal chamber pressure adjustment value for pressurization are set. Next, the external chamber pressure is adjusted, such that the increase of the external chamber pressure is equal to the external chamber pressure adjustment value. Then, the internal chamber pressure is adjusted, such that the increase of the internal chamber pressure is equal to the internal chamber pressure adjustment value. Specifically, the external pressurizing component 121 and the external chamber pressure control component 123 are first used to control the increase of the external chamber pressure. The increasing of the external chamber pressure stops when the external chamber pressure reaches the set value. Then, the internal pressurizing component 131 and the internal chamber pressure control component 133 are used to control the increase of the internal chamber pressure. The increasing of the internal chamber pressure stops when the internal chamber pressure reaches the set value. Then, the next stage of pressurization is performed, in which the external chamber pressure is increased and then the internal chamber pressure is increased, until the external chamber pressure reaches the final external chamber pressure value and the internal chamber pressure reaches the final internal chamber pressure value.

Referring to FIG. 5C and FIG. 5D, FIG. 5C and FIG. 5D are respectively schematic device diagrams when the dual-chamber pressure control method sequentially reduces the internal chamber pressure and the external chamber pressure. In each stage of the stepped pressure adjustment step in the decompression process, the external chamber pressure adjustment value and the internal chamber pressure adjustment value for decompression are set. Next, the internal chamber pressure is adjusted, such that the decrease of the internal chamber pressure is equal to the internal chamber pressure adjustment value. Then, the external chamber pressure is adjusted, such that the decrease of the external chamber pressure is equal to the external chamber pressure adjustment value. Specifically, the internal chamber pressure control component 133 is first used to control the decrease of the internal chamber pressure. The decreasing of the internal chamber pressure stops when the internal chamber pressure reaches the set value. Then, the external chamber pressure control component 123 is used to control the decrease of the external chamber pressure. The decreasing of the external chamber pressure stops when the external chamber pressure reaches the set value. Then, the next stage of decompression is performed, in which the internal chamber pressure is decreased and then the external chamber pressure is decreased, until the internal chamber pressure reaches the final internal chamber pressure value and the external chamber pressure reaches the final external chamber pressure value.

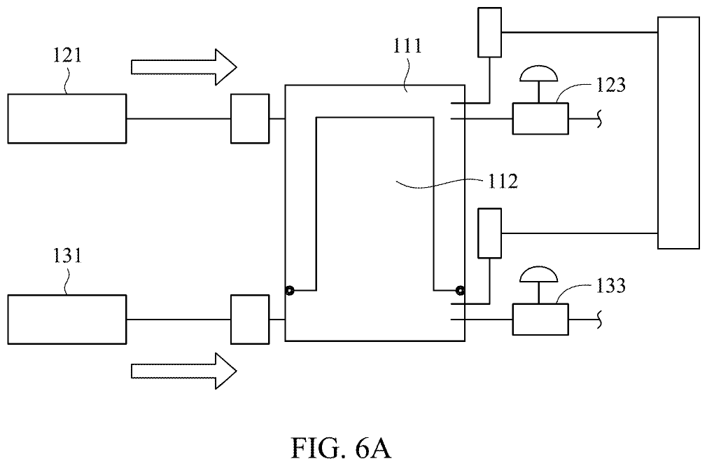

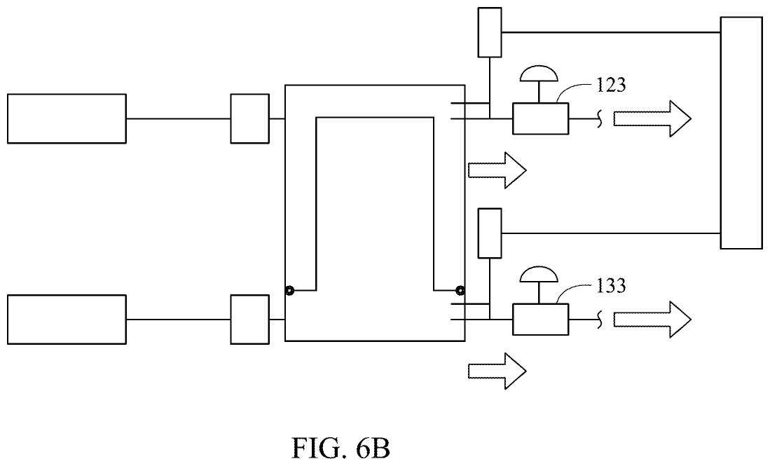

Referring to FIG. 6A, FIG. 6A is a schematic device diagram when the dual-chamber pressure control method simultaneously increases the external chamber pressure and the internal chamber pressure. In each stage of the stepped pressure adjustment step in the pressurization process, the external chamber pressure adjustment value and the internal chamber pressure adjustment value for pressurization are set. Next, the internal chamber pressure and the external chamber pressure are simultaneously adjusted, that is, the internal chamber 112 and the external chamber 111 are simultaneously pressurized. Specifically, the external pressurizing component 121 and the external chamber pressure control component 123 are used to control the increase of the external chamber pressure. The increasing of the external chamber pressure stops when the external chamber pressure reaches the set value. Simultaneously, the internal pressurizing component 131 and the internal chamber pressure control component 133 are used to control the increase of the internal chamber pressure. The increasing of the internal chamber pressure stops when the internal chamber pressure reaches the set value. Then, the next stage of pressurization is performed, in which the external chamber pressure and the internal chamber pressure are simultaneously increased, until the external chamber pressure reaches the final external chamber pressure value and the internal chamber pressure reaches the final internal chamber pressure value.

Referring to FIG. 6B, FIG. 6B is a schematic device diagram when the dual-chamber pressure control method simultaneously reduces the pressure of the external chamber pressure and the internal chamber pressure. In each stage of the stepped pressure adjustment step in the decompression process, the external chamber pressure adjustment value and the internal chamber pressure adjustment value for decompression are set. Next, the internal chamber pressure and the external chamber pressure are simultaneously adjusted. Specifically, the external chamber pressure control component 123 is used to control the decrease of the external chamber pressure. The decreasing of the external chamber pressure stops when the external chamber pressure reaches the set value. Simultaneously, the internal chamber pressure control component 133 is used to control the decrease of the internal chamber pressure. The decreasing of the internal chamber pressure stops when the internal chamber pressure reaches the set value. Then, the next stage of decompression is performed, in which the external chamber pressure and the internal chamber pressure are simultaneously decreased, until the external chamber pressure reaches the final external chamber pressure value and the internal chamber pressure reaches the final internal chamber pressure value.

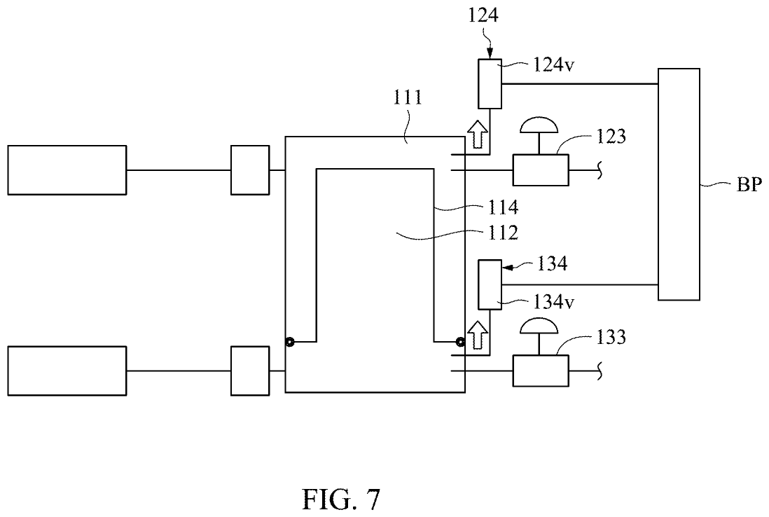

Referring to FIG. 7, FIG. 7 is a schematic device diagram when the dual chamber pressure control method uses the external chamber pressure protection component 124 and the internal chamber pressure protection component 134 to assist the adjustment of the external chamber pressure and the internal chamber pressure. In each stage of the stepped pressure adjustment step in the pressurization process, the external chamber pressure adjustment value and the internal chamber pressure adjustment value for pressurization are set. Next, the internal chamber pressure and the external chamber pressure are simultaneously adjusted, that is, the internal chamber 112 and the external chamber 111 are simultaneously pressurized. The external chamber pressure protection component 124 and the internal chamber pressure protection component 134 are used to ensure that the external chamber 111 and the internal chamber 112 are at equal pressure. The set pressure value of the external chamber pressure protection component 124 is greater than the set pressure value of the external chamber pressure control component 123 by 1 bar. The set pressure value of the internal chamber pressure protection component 134 is greater than the set pressure value of the internal chamber pressure control component 133 by 1 bar. When the internal chamber pressure of the internal chamber 112 exceeds the set pressure value of the internal chamber pressure protection component 134, the reactive gas in the internal chamber 112 can be discharged through the internal chamber pressure protection component 134. When the external chamber pressure of the external chamber 111 exceeds the set pressure value of the external chamber pressure protection component 124, the inert gas in the external chamber 111 can be discharged through the external chamber pressure protection component 124. The internal chamber body 114 is protected by the pressure adjustment of the internal chamber pressure protection component 134 and the external chamber pressure protection component 124, thereby preventing the internal chamber body 114 from being damaged. In each stage of stepped pressure adjustment, the set pressure values of the internal chamber pressure protection component 134 and the external chamber pressure protection component 124 are the same to ensure the pressure balance between the internal chamber 112 and the external chamber 111.

According to the aforementioned embodiments, it is known that the dual-chamber pressure control method uses the external chamber pressure control module and the internal chamber pressure control module of the dual-chamber pressure control device to perform stepped pressure adjustments on the external chamber pressure and the internal chamber pressure respectively, such that it can ensure that the pressure adjustment at each stage will not exceed the safe value that the internal chamber body can withstand and the pressure will not be increased too quickly. Therefore, the dual-chamber pressure control method and the dual-chamber pressure control device can prevent the internal chamber body from being damaged, and the inert gas and the reactive gas from mixing, which facilitates the recovery of the reactive gas. The internal chamber of the double-chamber member is not communicating with the external chamber, such that it can prevent the inert gas and the reactive gas from mixing. The sealing ring can enhance an isolation effect between the inert gas and the reactive gas.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A dual-chamber pressure control method, comprising:
using an external chamber pressure control module and an internal chamber pressure control module to respectively obtain an external chamber pressure value and an internal chamber pressure value of a double-chamber member before pressure adjusting;
performing a stepped pressure adjustment to use the external chamber pressure control module to adjust an external chamber pressure adjustment value of an inert gas in an external chamber, and to use the internal chamber pressure control module to adjust an internal chamber pressure adjustment value for a reactive gas in an internal chamber; and
repeating the stepped pressure adjustment a plurality of times until the external chamber pressure value is adjusted to a final external chamber pressure value, and the internal chamber pressure value is adjusted to a final internal chamber pressure value.

2. The dual-chamber pressure control method of claim 1, wherein in the stepped pressure adjustment, the external chamber pressure adjustment value is increased first, and then the internal chamber pressure adjustment value is increased.

3. The dual-chamber pressure control method of claim 1, wherein in the stepped pressure adjustment, the internal chamber pressure adjustment value is decreased first, and then the external chamber pressure adjustment value is decreased.

4. The dual-chamber pressure control method of claim 1, wherein in the stepped pressure adjustment, the internal chamber pressure adjustment value and the external chamber pressure adjustment value are adjusted simultaneously.

5. The dual-chamber pressure control method of claim 1, wherein in the stepped pressure adjustment, the internal chamber pressure adjustment value and the external chamber pressure adjustment value are adjusted simultaneously, and an external chamber pressure protection component and an internal chamber pressure protection component are used to ensure that the external chamber and the internal chamber are at equal pressure.

6. The dual-chamber pressure control method of claim 1, wherein the external chamber pressure adjustment value is ranging from 0.01 bar to 20 bar, and the internal chamber pressure adjustment value is ranging from 0.01 bar to 20 bar.

7. A dual-chamber pressure control device, comprising:
a dual-chamber member comprising:
an external chamber configured to accommodate an inert gas; and
an internal chamber adjacent to the external chamber and not communicating with the external chamber, and configured to accommodate a reactive gas;
an external chamber pressure control module connected to the external chamber and configured to adjust an external chamber pressure of the inert gas in the external chamber, such that an external chamber pressure value of the external chamber changes with time to show a stepped external chamber pressure adjustment line; and
an internal chamber pressure control module connected to the internal chamber and configured to adjust an internal chamber pressure of the reactive gas in the internal chamber, such that an internal chamber pressure value of the internal chamber changes with time to show a stepped internal chamber pressure adjustment line.

8. The dual-chamber pressure control device of claim 7, wherein
the external chamber pressure control module comprises:
an external pressurizing component connected to the external chamber and configured to increase the external chamber pressure value;
an external chamber pressure transmission component connected to the external chamber and configured to measure the external chamber pressure value; and
an external chamber pressure control component connected to the external chamber and configured to control the external chamber pressure value; and
the internal chamber pressure control module comprises:
an internal pressurizing component connected to the internal chamber and configured to increase the internal chamber pressure value;
an internal chamber pressure transmission component connected to the internal chamber and configured to measure the internal chamber pressure value; and
an internal chamber pressure control component connected to the internal chamber and configured to control the internal chamber pressure value.

9. The dual-chamber pressure control device of claim 8, wherein each of the external pressurizing component and the internal pressurizing component is a boosting pump, a combination of the boosting pump and a mass flow meter, or a combination of the boosting pump and a mass flow controller.

10. The dual-chamber pressure control device of claim 8, wherein each of the external chamber pressure transmission component and the internal chamber pressure transmission component is a pressure transmitter, or a combination of the pressure transmitter and a differential pressure transmitter.

11. The dual-chamber pressure control device of claim 8, wherein each of the external chamber pressure control component and the internal chamber pressure control component is a pressure regulator, an electronic pressure control valve, or a combination of the pressure regulator and the electronic pressure control valve.

12. The dual-chamber pressure control device of claim 8, wherein
the external chamber pressure control module comprises:
an external chamber pressure protection component connected to the external chamber, wherein a set pressure value of the external chamber pressure protection component is greater than a set pressure value of the external chamber pressure control component by 0.3 bar to 3 bar; and
the internal chamber pressure control module comprises:
an internal chamber pressure protection component connected to the internal chamber, wherein a set pressure value of the internal chamber pressure protection component is greater than a set pressure value of the internal chamber pressure control component by 0.3 bar to 3 bar.

13. The dual-chamber pressure control device of claim 8, wherein the dual-chamber member comprises:
an external chamber body;
an internal chamber body disposed in the external chamber body; and
a sealing ring disposed between the external chamber body and the internal chamber body, and configured to isolate the inert gas in the external chamber and the reactive gas in the internal chamber.

14. The dual-chamber pressure control device of claim 13, wherein the internal chamber body is a component made of a non-metallic material or an anti-pollution metal material.

15. The dual-chamber pressure control device of claim 14, wherein a material of the internal chamber body comprises quartz, ceramics, glass, silicon carbide, or nickel alloy.
